(19) United States
(12) Patent Application Publication
(10) Pub. No.: US 2025/0299430 A1
(43) Pub. Date: Sep. 25, 2025

(54) FOUR-DIMENSIONAL SCENE RECONSTRUCTION METHOD AND APPARATUS, AND ELECTRONIC DEVICE

(71) Applicant: Beijing Zitiao Network Technology Co., Ltd., Beijing (CN)

(72) Inventors: Panwang PAN, Beijing (CN); Zeming LI, Beijing (CN)

(21) Appl. No.: 19/087,555

(22) Filed: Mar. 23, 2025

(30) Foreign Application Priority Data
Mar. 22, 2024 (CN) 202410339079.4

(51) Int. Cl. G06T 15/20; G06T 17/00

(52) U.S. Cl. CPC G06T 15/205; G06T 17/00; G06T 2210/56

(57) ABSTRACT

Embodiments of the present application disclose a four-dimensional scene reconstruction method and apparatus, and an electronic device. A specific implementation of the method includes: obtaining a multi-view video, where the multi-view video includes multi-view images, which include a video frame at an initial moment in the multi-view video; generating a three-dimensional scene model corresponding to the multi-view images; determining a deformable network corresponding to the multi-view video based on the three-dimensional scene model, the multi-view video, and camera pose information corresponding to the multi-view video; and determining a four-dimensional scene model corresponding to the multi-view video based on the three-dimensional scene model and the deformable network.

### CROSS-REFERENCE TO RELATED APPLICATION

This application claims priority to Chinese Application No. 202410339079.4 filed on Mar. 22, 2024, the disclosure of which is incorporated herein by reference in its entirety.

### FIELD

Embodiments of the present disclosure relate to the field of computer technologies, and in particular, to a four-dimensional scene reconstruction method and apparatus, and an electronic device.

### BACKGROUND

4D scene modeling has always been a hot research topic in the field of computer vision. A 4D scene modeling manner allows a user to freely explore a dynamic scene from any view and at any timestamp. In a spatial dimension, the user may freely move a camera to switch a view, to display an image at six degrees of freedom (6DoF). In a time dimension, there may be changes and motions in a scene. This provides intense immersive experience and can greatly benefit applications in the fields of virtual reality (VR)/augmented reality (AR), media, education, and the like.

### SUMMARY

This section of the present disclosure is provided to give a brief overview of concepts, which will be described in detail later in the Detailed Description section. This section of the present disclosure is not intended to identify key features or essential features of the claimed technical solution, nor is it intended to limit the scope of the claimed technical solution.

According to a first aspect, an embodiment of the present disclosure provides a four-dimensional scene reconstruction method. The method includes: obtaining a multi-view video, where the multi-view video includes multi-view images, which include a video frame at an initial moment in the multi-view video; generating a three-dimensional scene model corresponding to the multi-view images; determining a deformable network corresponding to the multi-view video based on the three-dimensional scene model, the multi-view video, and camera pose information corresponding to the multi-view video; and determining a four-dimensional scene model corresponding to the multi-view video based on the three-dimensional scene model and the deformable network.

According to a second aspect, an embodiment of the present disclosure provides a four-dimensional scene reconstruction apparatus. The apparatus includes: an obtaining unit configured to obtain a multi-view video, where the multi-view video includes multi-view images, which include a video frame at an initial moment in the multi-view video; a generation unit configured to generate a three-dimensional scene model corresponding to the multi-view images; a first determination unit configured to determine a deformable network corresponding to the multi-view video based on the three-dimensional scene model, the multi-view video, and camera pose information corresponding to the multi-view video; and a second determination unit configured to determine a four-dimensional scene model corresponding to the multi-view video based on the three-dimensional scene model and the deformable network.

According to a third aspect, an embodiment of the present disclosure provides an electronic device. The electronic device includes: one or more processors; and a storage apparatus configured to store one or more programs, where the one or more programs, when executed by the one or more processors, cause the one or more processors to implement the four-dimensional scene reconstruction method according to the first aspect.

According to a fourth aspect, an embodiment of the present disclosure provides a computer-readable medium having stored therein a computer program. The program, when executed by a processor, causes the steps of the four-dimensional scene reconstruction method according to the first aspect to be implemented.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a flowchart of an embodiment of a four-dimensional scene reconstruction method according to the present disclosure;

FIG. 2 is a flowchart of another embodiment of a four-dimensional scene reconstruction method according to the present disclosure;

FIG. 3 is a flowchart of still another embodiment of a four-dimensional scene reconstruction method according to the present disclosure;

FIG. 4 is a schematic diagram of an embodiment of generating a three-dimensional scene model in a four-dimensional scene reconstruction method according to the present disclosure;

FIG. 5 is a schematic diagram of an embodiment of generating a four-dimensional scene in a four-dimensional scene reconstruction method according to the present disclosure;

FIG. 6 is a schematic diagram of another embodiment of generating a four-dimensional scene model in a four-dimensional scene reconstruction method according to the present disclosure;

FIG. 7 is a schematic diagram of a structure of an embodiment of a four-dimensional scene reconstruction apparatus according to the present disclosure;

FIG. 8 is a diagram of an exemplary system architecture to which embodiments of the present disclosure can be applied; and

FIG. 9 is a schematic diagram of a structure of a computer system of an electronic device suitable for implementing an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

According to the four-dimensional scene reconstruction method and apparatus, and the electronic device provided in the embodiments of the present disclosure, the multi-view video is obtained; then, the three-dimensional scene model corresponding to the video frame at the initial moment in the multi-view video is generated; next, the deformable network corresponding to the multi-view video is determined based on the three-dimensional scene model, the multi-view video, and the camera pose information corresponding to the multi-view video; and finally, the four-dimensional scene model corresponding to the multi-view video is determined based on the three-dimensional scene model and the deformable network. In this way, a 3D static scene is first reconstructed, and a spatial representation of the scene is established by capturing a geometric structure and a surface feature of the scene. Then, the scene is modeled in a time dimension through the deformable network, to accurately capture motions and changes in the scene. Therefore, a four-dimensional scene reconstruction effect is improved.

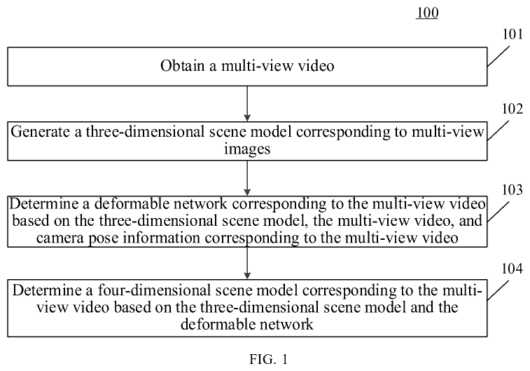

Reference is made to FIG. 1, which shows a process 100 of an embodiment of a four-dimensional scene reconstruction method according to the present disclosure. The four-dimensional scene reconstruction method includes the following steps.

Step 101: Obtain a multi-view video.

In this embodiment, an execution body of the four-dimensional scene reconstruction method may obtain the multi-view video. Herein, the multi-view video usually includes multi-view images, which usually include a video frame corresponding to an initial moment in the multi-view video, i.e., a first frame in the multi-view video.

An excessively small number of multi-view images may result in inadequate model quality, and an excessively large number of multi-view images may result in an excessive training time. In an example, 32 images in each of eight views may be obtained.

In some application scenarios, the four-dimensional scene reconstruction method may be applied to an extended reality (XR) device. XR describes a series of methods for changing reality. Since XR is a generic term of a variety of technologies such as virtual reality (VR), AR, and MR, the XR device usually includes a VR device, an AR device, and an MR device. The XR device may obtain the multi-view video and the multi-view images inputted by a user, to generate a corresponding four-dimensional scene.

Step 102: Generate a three-dimensional scene model corresponding to the multi-view images.

In this embodiment, the execution body may generate a three-dimensional scene model corresponding to the multi-view images. Herein, the multi-view images may be inputted into a three-dimensional scene generation model, to obtain the three-dimensional scene model corresponding to the multi-view images. The three-dimensional scene generation model may be configured to represent a correspondence between the multi-view images and the three-dimensional scene model.

Step 103: Determine a deformable network corresponding to the multi-view video based on the three-dimensional scene model, the multi-view video, and camera pose information corresponding to the multi-view video.

In this embodiment, the execution body may determine the deformable network corresponding to the multi-view video based on the three-dimensional scene model, the multi-view video, and the camera pose information corresponding to the multi-view video.

The deformable network may add a spatial sampling position to a module using an additional offset, without additional supervision, and learn an offset from a target task. The offset may represent an offset of a position at a moment T relative to a position at a moment T-1. An input of the deformable network usually includes a target moment, and an output of the deformable network is usually an offset corresponding to the target moment in the multi-view video, i.e., an offset of a position at the moment T in the multi-view video relative to a position at the moment T-1 or at the initial moment.

Herein, the execution body may input the three-dimensional scene model, the multi-view video, and the camera pose information corresponding to the multi-view video into a pretrained deformable network generation model, to obtain the deformable network corresponding to the multi-view video.

Step 104: Determine a four-dimensional scene model corresponding to the multi-view video based on the three-dimensional scene model and the deformable network.

In this embodiment, the execution body may determine the four-dimensional scene model corresponding to the multi-view video based on the three-dimensional scene model and the deformable network. Specifically, the offset of the position at the moment T relative to the position at the moment T-1 or at the initial moment is determined using the deformable network, and then the three-dimensional scene model (i.e., a three-dimensional scene model at the initial moment) is offset using the offset, to obtain the four-dimensional scene model corresponding to the multi-view video.

The execution body may reconstruct the four-dimensional scene model corresponding to the multi-view video using the offset and the three-dimensional scene model. Herein, the execution body may determine a 3D point cloud at any moment according to the following formula (1):

$$\vec{{p}^{{}_{t}}} = \vec{{p}^{{}_{0}}} + \vec{{δ}_{p}^{t}} \qquad ( 1 )$$

where \vec{p^{t}} represents a 3D point cloud at a moment t, \vec{p⁰} represents a static point cloud at a moment t-1, and \vec{δₚ^{t}} represents an offset at the moment t.

A 3D point cloud at any moment in a time period corresponding to the multi-view video may be determined according to formula (1), and 3D point clouds in this time period are synthesized to generate a dynamic point cloud, i.e., the four-dimensional scene model corresponding to the multi-view video.

Herein, the execution body may perform training based on the three-dimensional scene model and the deformable network, to obtain the four-dimensional scene model corresponding to the multi-view video, i.e., a fusion model. The four-dimensional scene model is obtained through training by using a sample moment and a sample view as an input of the fusion model, and scene information corresponding to the sample moment and the sample view as an output of the fusion model. The four-dimensional scene model obtained through training in this way occupies a smaller storage space and costs less computing power.

According to the method provided in the above embodiment of the present disclosure, the multi-view video is obtained; then, the three-dimensional scene model corresponding to the video frame at the initial moment in the multi-view video is generated; next, the deformable network corresponding to the multi-view video is determined based on the three-dimensional scene model, the multi-view video, and the camera pose information corresponding to the multi-view video; and finally, the four-dimensional scene model corresponding to the multi-view video is determined based on the three-dimensional scene model and the deformable network. In this way, a 3D static scene is first reconstructed, and a spatial representation of the scene is established by capturing a geometric structure and a surface feature of the scene. Then, the scene is modeled in a time dimension through the deformable network, to accurately capture motions and changes in the scene. Therefore, a four-dimensional scene reconstruction effect is improved.

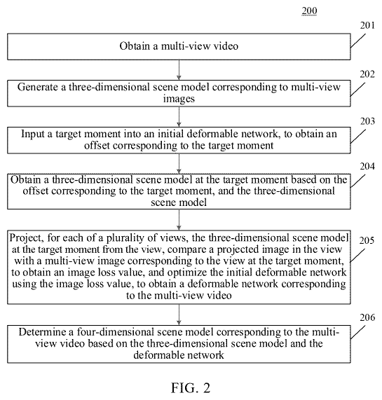

Reference is made to FIG. 2, which shows a process 200 of another embodiment of a four-dimensional scene reconstruction method. The process 200 of the four-dimensional scene reconstruction method includes the following steps.

Step 201: Obtain a multi-view video.

Step 202: Generate a three-dimensional scene model corresponding to multi-view images.

In this embodiment, steps 201 and 202 may be performed in a manner similar to that in steps 101 and 102, and are not described in detail herein again.

Step 203: Input a target moment into an initial deformable network, to obtain an offset corresponding to the target moment.

In this embodiment, an execution body of the four-dimensional scene reconstruction method may input the target moment into the initial deformable network, to obtain the offset corresponding to the target moment. The target moment may be any moment corresponding to the multi-view video. The initial deformable network is usually an untrained or incompletely trained deformable network. A parameter of the initial deformable network is optimized through subsequent processing, to obtain a trained deformable network. Specifically, inputting the target moment into the initial deformable network may be understood as inputting a temporal feature and a spatial feature of the target moment into the initial deformable network.

Step 204: Obtain a three-dimensional scene model at the target moment based on the offset corresponding to the target moment, and the three-dimensional scene model.

In this embodiment, the execution body may obtain the three-dimensional scene model at the target moment based on the offset corresponding to the target moment and the three-dimensional scene model corresponding to an initial moment.

Herein, the execution body knows a 3D point cloud at the initial moment and the offset corresponding to the target moment, and may determine 3D point clouds at the above moments according to formula (1).

Step 205: Project, for each of a plurality of views, the three-dimensional scene model at the target moment from the view, compare a projected image in the view with a multi-view image corresponding to the view at the target moment, to obtain an image loss value, and optimize the initial deformable network using the image loss value, to obtain a deformable network corresponding to the multi-view video.

In this embodiment, the execution body may project, for each of the plurality of views, the three-dimensional scene model at the target moment from the view, compare the projected image in the view with the multi-view image corresponding to the view at the target moment, to obtain the image loss value, and optimize the initial deformable network using the image loss value until the initial deformable network converges, to obtain the deformable network corresponding to the multi-view video.

The execution body may determine a loss value according to the following formula (2):

$$ℒ ( y , \hat{y} ) = {\sum }_{i = 1}^{n} \vert {y}_{i} - {\hat{y}}_{i} \vert \qquad ( 2 )$$

where [symbol] (y, ŷ) represents a total loss value, yᵢ represents an image in an i^{th} view at the target moment, ŷᵢ represents an image in the i^{th} view at the target moment, which is rendered by the three-dimensional scene model, and n represents the number of views.

Step 206: Determine a four-dimensional scene model corresponding to the multi-view video based on the three-dimensional scene model and the deformable network.

It can be seen from FIG. 2 that, compared with the embodiment corresponding FIG. 1, the process 200 of the four-dimensional scene reconstruction method in this embodiment embodies the step of optimizing the initial deformable network to obtain the deformable network corresponding to the multi-view video. Therefore, according to the solution described in this embodiment, accuracy of an output result of the deformable network can be improved.

In some optional implementations, a specified moment and a specified view may be determined after the four-dimensional scene model is reconstructed. The specified moment and the specified view may be a moment and a view specified by a user when executing a viewing instruction. The execution body may input the specified moment and the specified view into the four-dimensional scene model, thereby outputting scene information corresponding to the specified moment and the specified view. The scene information may include, but is not limited to, an image and a depth corresponding to the specified view at the specified moment. In this way, scene information at a moment and in a view of interest of the user may be outputted, to output a more realistic four-dimensional scene to the user, improving the user experience.

In some optional implementations, the execution body may input the target moment into the initial deformable network, to obtain the offset corresponding to the target moment in the following manner: The execution body combines the temporal feature and the spatial feature of the target moment, to obtain combined feature information. The temporal feature of the target moment may be determined based on the target moment, and the spatial feature may be determined based on a point cloud position of the three-dimensional scene, and camera pose information corresponding to the multi-view video.

Specifically, the temporal feature may be obtained by encoding the target moment, and the spatial feature may be obtained by encoding the point cloud position of the three-dimensional scene, and the camera pose information corresponding to the multi-view video. The execution body may perform encoding according to the following formula (3):

$$γ ( p ) = {( sin ( {2}^{k} π p ) , cos ( {2}^{k} π p ) )}_{k = 0}^{L - 1} , \qquad ( 3 )$$

where p represents a variable to be encoded, γ(p) represents a temporal code or a position code, L represents an order of a sine function and a cosine function, and may be set to 10 herein, and k represents k^{th} order encoding.

Any position (x, y, z) may be encoded using 10 frequencies such as [1, 2, 4, 8, 16, 32, 64, 128, 256, 512], where two phases, i.e., the sine function and the cosine function, are used for each frequency. An encoded position needs to have 3×10×2=60 dimensions to represent an original three-dimensional coordinate vector. Any moment t is encoded into a vector of 1×10×2=20 dimensions to represent an original moment.

In an example, the execution body may combine any three of the temporal feature and spatial features in three dimensions, i.e., perform recombination according to xyz, xyt, xzt, and yzt. Then, the combined feature information may be inputted into the initial deformable network, to obtain the offset corresponding to the target moment.

In this way, feature representations can be enriched, and accuracy of the offset can be improved, further improving a four-dimensional scene reconstruction effect.

In some optional implementations, the deformable network may include a multilayer perceptron. The execution body may input the combined feature information into the multilayer perceptron (MLP), to obtain the corresponding offset. In an example, a six-layer fully connected network may be used.

In some optional implementations, the combined feature information may include a pairwise combination of the temporal feature and spatial features in three dimensions. Specifically, the features may be recombined according to xt, yt, zt, xy, yz, and xz. In this way, a feature dimension can be improved. In other words, an original input (x, y, z, t) is four-dimensional, and a recombined vector is six-dimensional. Therefore, there are more vector features, and a four-dimensional scene reconstruction effect is further improved.

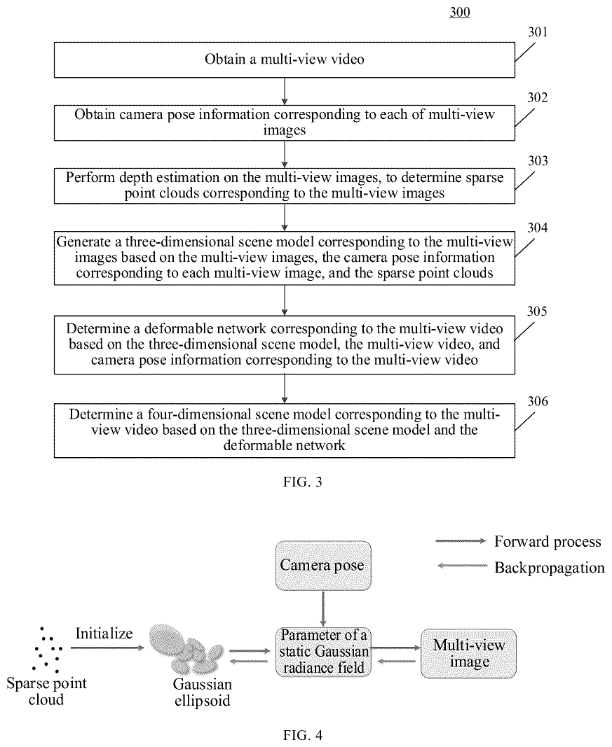

Reference is made to FIG. 3, which shows a process 300 of still another embodiment of a four-dimensional scene reconstruction method. The process 300 of the four-dimensional scene reconstruction method includes the following steps.

Step 301: Obtain a multi-view video.

In this embodiment, step 301 may be performed in a manner similar to that in step 101, and is not described in detail herein again.

Step 302: Obtain camera pose information corresponding to each of multi-view images.

In this embodiment, an execution body of the four-dimensional scene reconstruction method may obtain the camera pose information corresponding to each of the multi-view images. The camera pose information includes an intrinsic camera parameter and an extrinsic camera parameter.

Herein, the camera pose information corresponding to each of multi-view images may be obtained using a structure from motion (SFM) algorithm, or may be directly obtained by a device with a light detection and ranging (Lidar) camera.

Step 303: Perform depth estimation on the multi-view images, to determine sparse point clouds corresponding to the multi-view images.

In this embodiment, the execution body may perform depth estimation on the multi-view images, to determine the sparse point clouds corresponding to the multi-view images. The execution body may estimate, using a multi-view image I (x, y), a depth D (x, y) of the multi-view image, and perform projection using an intrinsic camera parameter K and extrinsic camera parameters R and t, to obtain a three-dimensional sparse point cloud.

First, pixel coordinates (x, y) may be converted to coordinates (X_{c}, Y_{c}, Z_{c}) in a camera coordinate system.

Then, the coordinates (X_{c}, Y_{c}, Z_{c}) in the camera coordinate system may be converted to coordinates (X_{w}, Y_{w}, Z_{w}) in a world coordinate system.

Next, a sparse point cloud may be scaled based on the depth value D (x, y). In this way, a three-dimensional point corresponding to each pixel may be generated using the estimated depth of the multi-view image.

Herein, depth estimation methods such as zero-shot transfer by combining relative and metric depth (ZoeDepth) or MVSNet (an end-to-end depth estimation framework based on deep learning) may be used to perform depth estimation on the multi-view image.

Step 304: Generate a three-dimensional scene model corresponding to the multi-view images based on the multi-view images, the camera pose information corresponding to each multi-view image, and the sparse point clouds.

In this embodiment, the execution body may generate the three-dimensional scene model corresponding to the multi-view images based on the multi-view images, the camera pose information corresponding to each multi-view image, and the sparse point clouds. Specifically, the execution body may generate the three-dimensional scene model corresponding to the multi-view images using three-dimensional reconstruction methods such as structure from motion (SFM) reconstruction, neural radiance field (NeRF) reconstruction, and neural implicit surface (NeuS) (a neural surface reconstruction method)/NeuS3 reconstruction.

Step 305: Determine a deformable network corresponding to the multi-view video based on the three-dimensional scene model, the multi-view video, and camera pose information corresponding to the multi-view video.

Step 306: Determine a four-dimensional scene model corresponding to the multi-view video based on the three-dimensional scene model and the deformable network.

In this embodiment, steps 305 and 306 may be performed in a manner similar to that in steps 103 and 104, and are not described in detail herein again.

It can be seen from FIG. 3 that, compared with the embodiment corresponding to FIG. 1, the process 300 of the four-dimensional scene reconstruction method in this embodiment embodies the step of generating a three-dimensional scene model corresponding to the multi-view images based on the multi-view images, the camera pose information corresponding to each multi-view image, and the sparse point clouds. Therefore, according to the solution described in this embodiment, a three-dimensional scene model generation effect can be improved.

In some optional implementations, the three-dimensional scene model may include a three-dimensional Gaussian radiance field (3D-Gaussian Splatting). The three-dimensional Gaussian radiance field is an explicit representation method of a 3D scene using a set of differentiable 3D Gaussian functions. Each Gaussian function is defined by a central position, a covariance matrix, a color, and an opacity. Specifically, a position and a covariance matrix of a 3D Gaussian sphere may be initialized first using a position of the sparse point cloud, and a color and an opacity of the 3D Gaussian sphere may be integrated using the multi-view image and the multi-view information. Due to the high rendering quality and high rendering speed of the three-dimensional Gaussian radiance field, in the solution described in this embodiment, a high-quality rendering result can be generated fast, improving the real-time performance of a system and the user experience.

In this way, a Gaussian function is associated with a motion feature of the scene, so that a dynamic change in the scene can be effectively represented. A Gaussian radiance field can maintain a high dynamic range and inter-frame consistency of the scene, making a result presented more realistic and coherent. In addition, requirements for rendering quality and a rendering speed are also considered in this solution. A high-quality rendering result can be generated fast using an optimization algorithm and an acceleration technology. Therefore, the user can view a dynamic scene smoothly, and realism and details in rendering are ensured.

Reference is made to FIG. 4, which is a schematic diagram of an embodiment of generating a three-dimensional scene model in the four-dimensional scene reconstruction method. In FIG. 4, a sparse point cloud may be initialized to obtain a Gaussian ellipsoid. Then, a multi-view image, a corresponding camera pose, and the Gaussian ellipsoid may be inputted into a static Gaussian radiance field, to obtain the three-dimensional scene model.

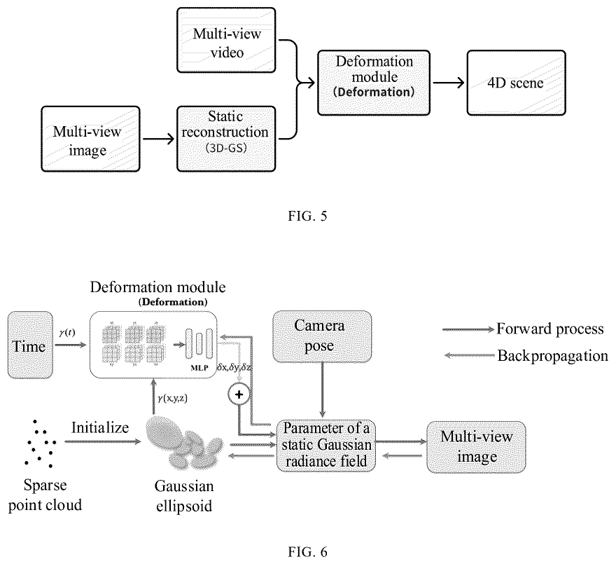

Further, reference is made to FIG. 5, which is a schematic diagram of an embodiment of generating a four-dimensional scene in the four-dimensional scene reconstruction method. In FIG. 5, a static three-dimensional scene may be first reconstructed using a multi-view image, to obtain a Gaussian ellipsoid. Then, a temporal feature and a spatial feature are determined based on a three-dimensional scene model, a multi-view video, and camera pose information corresponding to the multi-view video, and are inputted into a deformable network to generate the 4D scene.

In some optional implementations, after the initialization of the three-dimensional Gaussian radiance field, the execution body may project, for each of a plurality of views, the three-dimensional Gaussian radiance field from the view, compare a projected image in the view with a multi-view image corresponding to the view, to obtain an image loss value, and may optimize a parameter of the three-dimensional Gaussian radiance field using the image loss value until the three-dimensional Gaussian radiance field converges, that is, optimize the central position, the covariance matrix, the color, and the opacity.

In this way, the parameter of the three-dimensional Gaussian radiance field can be optimized to improve the accuracy of the three-dimensional Gaussian radiance field.

Reference is made to FIG. 6, which is a schematic diagram of another embodiment of generating a four-dimensional scene model in the four-dimensional scene reconstruction method. In FIG. 6, a sparse point cloud may be initialized to obtain a Gaussian ellipsoid. Then, a multi-view image, a corresponding camera pose, and the Gaussian ellipsoid may be inputted into a static Gaussian radiance field, to obtain a three-dimensional scene model. Next, a target moment is encoded to obtain a temporal code γ(t), and a point cloud position of a three-dimensional scene and camera pose information are encoded to obtain a spatial code γ(x,y,z). The temporal code γ(t) and the spatial code γ(x,y,z) are inputted into a deformation module, to obtain an offset δₓ, δ_{y}, δ_{z}, and the four-dimensional scene model is determined using the offset δₓ, δ_{y}, δz and the three-dimensional scene model outputted by the static Gaussian radiance field. Herein, the deformation module first recombines the features according to xt, yt, zt, xy, yz, and xz, and then inputs a combined feature into an MLP network, to obtain the offset δₓ, δ_{y}, δ_{z}. During backpropagation, a view may be fixed, a projected video of the four-dimensional scene model in the view is supervised using a multi-view video in the view as a dummy tag, and a network parameter of the deformation module and a parameter of the Gaussian radiance field are updated.

In some optional implementations, the execution body may project, for each of a plurality of views, the four-dimensional scene model from the view, compare a projected video in the view with a multi-view video corresponding to the view, to obtain a video loss value, and optimize a network parameter of a target network using the video loss value. Herein, the target network may include the deformable network. In other words, a parameter of a multilayer perceptron of the deformable network is optimized.

In an example, the execution body may determine a loss value L according to the following formula (4):

$$ℒ = ( 1 - λ ) {ℒ}_{1} + {λℒ}_{D - SSIM} \qquad ( 4 )$$

where L_{D-SSIM} represents a structural similarity index loss, λ represents a weighting parameter ranging from 0 to 1, and L1 measures a mean of absolute values of differences between elements of the two vectors, whose mathematical expression is shown in the following formula (5):

$${L}_{1} ( {x}^{{}_{{}_{′}}} y ) = \frac{1}{N} {\sum }_{i = 1}^{N} \vert {x}_{i} - {y}_{i} \vert \qquad ( 5 )$$

where x and y are two vectors to be compared, and N is a dimension of the vector. A mathematical expression of L_{D-SSIM} is shown in the following formula (6):

$${L}_{D - S S I M} ( x , y ) = 1 - S S I M ( x , y ) \qquad ( 6 )$$

where SSIM(x, y) represents a structural similarity indicator, whose mathematical expression is shown in the following formula (7):

$$SSIM ( x , y ) = \frac{( 2 {μ}_{x} {μ}_{y} + {C}_{1} ) ( 2 {σ}_{x y} + {C}_{2} )}{( {μ}_{x}^{2} + {μ}_{y}^{2} + {C}_{1} ) ( {σ}_{x}^{2} + {σ}_{y}^{2} + {C}_{2} )} \qquad ( 7 )$$

where μₓ and μ_{y} represent means of x and y, respectively, σₓ and σ_{y} represent standard deviations of x and y, respectively, σ_{xy} represents a covariance of x and y, and C₁ and C₂ are constants for stability calculation. SSIM ranges from 0 to 1, and a larger value indicates a higher structural similarity between the two vectors.

In this way, a parameter of the deformable network can be optimized, improving accuracy of the deformable network. In addition, projection of a scene into a video for difference comparison can increase smoothing constraints and ensure higher smoothness between adjacent frames.

In some optional implementations, the target network may further include a three-dimensional Gaussian radiance field, where the three-dimensional Gaussian radiance field may be used to determine the three-dimensional scene model corresponding to the multi-view image. In this way, both the parameter of the deformable network and a parameter of the three-dimensional Gaussian radiance field can be updated. In other words, not only the deformable network is learned, but also an initial static point cloud parameter is updated. Therefore, network parameters used in the entire four-dimensional scene reconstruction process can be optimized, further improving the four-dimensional scene reconstruction effect.

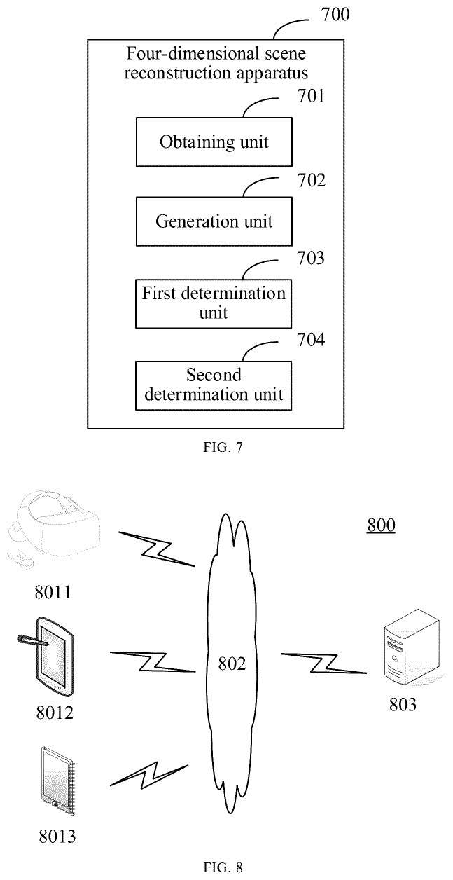

Further, reference is made to FIG. 7. As an implementation of the method shown in the above figures, the present application provides an embodiment of a four-dimensional scene reconstruction apparatus. The apparatus embodiment corresponds to the method embodiment shown in FIG. 1. The apparatus is specifically applicable to various electronic devices.

As shown in FIG. 7, the four-dimensional scene reconstruction apparatus 700 in this embodiment includes an obtaining unit 701, a generation unit 702, a first determination unit 703, and a second determination unit 704. The obtaining unit 701 is configured to obtain a multi-view video, where the multi-view video includes multi-view images, which include a video frame at an initial moment in the multi-view video. The generation unit 702 is configured to generate a three-dimensional scene model corresponding to the multi-view images. The first determination unit 703 is configured to determine a deformable network corresponding to the multi-view video based on the three-dimensional scene model, the multi-view video, and camera pose information corresponding to the multi-view video. The second determination unit 704 is configured to determine a four-dimensional scene model corresponding to the multi-view video based on the three-dimensional scene model and the deformable network.

In this embodiment, for specific processing of the obtaining unit 701, the generation unit 702, the first determination unit 703, and the second determination unit 704 of the four-dimensional scene reconstruction apparatus 700, reference may be made to step 101, step 102, step 103, and step 104 in the embodiment corresponding FIG. 1.

In some optional implementations, the first determination unit 703 may further be configured to determine the deformable network corresponding to the multi-view video based on the three-dimensional scene model, the multi-view video, and the camera pose information corresponding to the multi-view video in the following manner: inputting a target moment into an initial deformable network, to obtain an offset corresponding to the target moment; obtaining a three-dimensional scene model at the target moment based on the offset corresponding to the target moment, and the three-dimensional scene model; and projecting, for each of a plurality of views, the three-dimensional scene model at the target moment from the view, comparing a projected image in the view with a multi-view image corresponding to the view at the target moment, to obtain an image loss value, and optimizing the initial deformable network using the image loss value, to obtain the deformable network corresponding to the multi-view video.

In some optional implementations, the four-dimensional scene reconstruction apparatus 700 may further include a third determination unit (not shown in the figure) and an output unit (not shown in the figure). The third determination unit is configured to determine a specified moment and a specified view. The output unit is configured to output scene information corresponding to the specified moment and the specified view.

In some optional implementations, the four-dimensional scene reconstruction apparatus 700 may further include a first optimization unit (not shown in the figure). The first optimization unit is configured to project, for each of a plurality of views, the four-dimensional scene model from the view, compare a projected video in the view with a multi-view video corresponding to the view, to obtain a video loss value, and optimize a network parameter of a target network using the video loss value, where the target network includes the deformable network.

In some optional implementations, the target network further includes a three-dimensional Gaussian radiance field, where the three-dimensional Gaussian radiance field is used to determine the three-dimensional scene model corresponding to the multi-view images.

In some optional implementations, the first determination unit 703 may further be configured to input the target moment into the initial deformable network, to obtain the offset corresponding to the target moment in the following manner: combining a temporal feature and a spatial feature of the target moment, to obtain combined feature information; and inputting the combined feature information into the initial deformable network, to obtain the offset corresponding to the target moment, where the temporal feature of the target moment is determined based on the target moment, and the spatial feature is determined based on a point cloud position of the three-dimensional scene, and the camera pose information corresponding to the multi-view video.

In some optional implementations, the deformable network includes a multilayer perceptron.

In some optional implementations, the combined feature information includes a pairwise combination of the temporal feature and spatial features in three dimensions.

In some optional implementations, the generation unit 702 may further be configured to generate the three-dimensional scene model corresponding to the multi-view images in the following manner: obtaining camera pose information corresponding to each of the multi-view images; performing depth estimation on the multi-view images, to determine sparse point clouds corresponding to the multi-view images; and generating the three-dimensional scene model corresponding to the multi-view image based on the multi-view images, the camera pose information corresponding to each multi-view image, and the sparse point clouds.

In some optional implementations, the three-dimensional scene model includes a three-dimensional Gaussian radiance field.

In some optional implementations, the four-dimensional scene reconstruction apparatus 700 may further include a second optimization unit (not shown in the figure). The second optimization unit is configured to project, for each of a plurality of views, the three-dimensional Gaussian radiance field from the view, compare a projected image in the view with a multi-view image corresponding to the view, to obtain an image loss value, and optimize a parameter of the three-dimensional Gaussian radiance field using the image loss value.

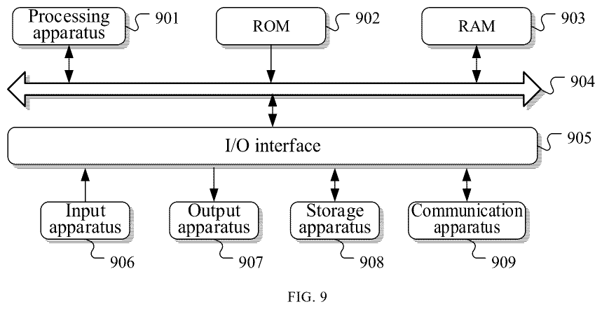

FIG. 8 shows an exemplary system architecture 800 to which an embodiment of a four-dimensional scene reconstruction method of the present disclosure can be applied.

As shown in FIG. 8, the system architecture 800 may include terminal devices 8011, 8012, and 8013, a network 802, and a server 803. The network 802 is a medium for providing a communication link between the terminal devices 8011, 8012, and 8013 and the server 803. The network 802 may include various connection types, such as wired and wireless communication links or fiber optic cables.

A user may interact with the server 803 through the network 802 using the terminal devices 8011, 8012, and 8013, to send or receive messages, etc. For example, the terminal devices 8011, 8012, and 8013 may obtain a multi-view video from the server 803. The terminal devices 8011, 8012, and 8013 may be installed with various communication client applications, such as a game application, an image capture application, a video processing application, a video playback application, and instant messaging software.

The terminal devices 8011, 8012, and 8013 may obtain a multi-view video, then generate a three-dimensional scene model corresponding to an initial video frame of the multi-view video, next determine a deformable network corresponding to the multi-view video based on the three-dimensional scene model, the multi-view video, and camera pose information corresponding to the multi-view video, and finally determine a four-dimensional scene model corresponding to the multi-view video based on the three-dimensional scene model and the deformable network.

The terminal devices 8011, 8012, and 8013 may be hardware or software. When being hardware, the terminal devices 8011, 8012, and 8013 may be various electronic devices having a camera and a display screen and supporting information exchange, including, but not limited to, an extended reality device, a smartphone, a tablet computer, a laptop computer, and the like. When being software, the terminal devices 8011, 8012, and 8013 may be installed on the electronic devices listed above. The terminal devices 8011, 8012, and 8013 may be implemented as a plurality of pieces of software or software modules (such as a plurality of pieces of software or software modules configured to provide distributed services), or may be implemented as a single piece of software or software module. This is not specifically limited herein.

The server 803 may be a server that provides various services. For example, the server 803 may be a backend server that provides a multi-view video for the terminal devices 8011, 8012, and 8013.

It should be noted that the server 803 may be hardware or software. When being hardware, the server 803 may be implemented as a distributed server cluster including a plurality of servers, or may be implemented as a single server. When being software, the server 803 may be implemented as a plurality of pieces of software or software modules (for example, configured to provide distributed services), or may be implemented as a single piece of software or software module. This is not specifically limited herein.

It should be further noted that if the four-dimensional scene reconstruction method provided in the embodiments of the present disclosure is usually performed by the terminal devices 8011, 8012, and 8013, the four-dimensional scene reconstruction apparatus is usually disposed on the terminal devices 8011, 8012, and 8013.

It should be understood that the numbers of terminal devices, networks, and servers in FIG. 8 are merely illustrative. According to implementation needs, there may be any number of terminal devices, networks, and servers.

Reference is made to FIG. 9 below, which is a schematic diagram of a structure of an electronic device (for example, the terminal device in FIG. 8) 900 suitable for implementing an embodiment of the present disclosure. The electronic device in this embodiment of the present disclosure may include, but is not limited to, mobile terminals such as an extended reality device, a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 9 is merely an example, and shall not impose any limitation on the function and scope of use of the embodiments of the present disclosure.

As shown in FIG. 9, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. It may be an alternative to implement or have more or fewer apparatuses. Each box shown in FIG. 9 may represent one or more apparatuses as required.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 909 and installed, installed from the storage apparatus 908, or installed from the ROM 902. When the computer program is executed by the processing apparatus 901, the above-mentioned functions defined in the method of the embodiment of the present disclosure are performed. It should be noted that the computer-readable medium described in this embodiment of the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In this embodiment of the present disclosure, the computer-readable storage medium may be any tangible medium containing or storing a program which may be used by or in combination with an instruction execution system, apparatus, or device. In this embodiment of the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device. The above computer-readable medium carries one or more programs that, when executed by the electronic device, cause the electronic device to: obtain a multi-view video, where the multi-view video includes multi-view images, which include a video frame at an initial moment in the multi-view video; generate a three-dimensional scene model corresponding to the multi-view images; determine a deformable network corresponding to the multi-view video based on the three-dimensional scene model, the multi-view video, and camera pose information corresponding to the multi-view video; and determine a four-dimensional scene model corresponding to the multi-view video based on the three-dimensional scene model and the deformable network.

The computer program code for performing the operations in the embodiments of the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The described units may also be disposed in the processor, which may be described, for example, as that the processor including the obtaining unit, the generation unit, the first determination unit, and the second determination unit. Names of the units do not include a limitation on the units themselves in some cases, for example, an obtaining unit may alternatively be described as “a unit for obtaining a multi-view video”.

The foregoing descriptions are merely preferred embodiments of the present disclosure and explanations of the applied technical principles. Those skilled in the art should understand that the scope of the present invention involved in the embodiments of the present disclosure is not limited to the technical solutions formed by particular combinations of the foregoing technical features, and shall also cover other technical solutions formed by any combination of the foregoing technical features or equivalent features thereof without departing from the foregoing concept of the present invention. For example, a technical solution formed by a replacement of the foregoing features with technical features with similar functions disclosed in the embodiments of the present disclosure (but not limited thereto) also falls within the scope of the present disclosure.

I/We claim:

1. A four-dimensional scene reconstruction method, comprising:
obtaining a multi-view video, wherein the multi-view video comprises multi-view images, which include a video frame at an initial moment in the multi-view video;
generating a three-dimensional scene model corresponding to the multi-view images;
determining a deformable network corresponding to the multi-view video based on the three-dimensional scene model, the multi-view video, and camera pose information corresponding to the multi-view video; and
determining a four-dimensional scene model corresponding to the multi-view video based on the three-dimensional scene model and the deformable network.

2. The method according to claim 1, wherein determining a deformable network corresponding to the multi-view video based on the three-dimensional scene model, the multi-view video, and camera pose information corresponding to the multi-view video comprises:
inputting a target moment into an initial deformable network, to obtain an offset corresponding to the target moment;
obtaining a three-dimensional scene model at the target moment based on the offset corresponding to the target moment, and the three-dimensional scene model; and
projecting, for each of a plurality of views, the three-dimensional scene model at the target moment from the view, comparing a projected image in the view with a multi-view image corresponding to the view at the target moment, to obtain an image loss value, and optimizing the initial deformable network using the image loss value, to obtain the deformable network corresponding to the multi-view video.

3. The method according to claim 1, wherein the method further comprises:
determining a specified moment and a specified view; and
outputting scene information corresponding to the specified moment and the specified view.

4. The method according to claim 1, wherein the method further comprises:
projecting, for each of a plurality of views, the four-dimensional scene model from the view, comparing a projected video in the view with a multi-view video corresponding to the view, to obtain a video loss value, and optimizing a network parameter of a target network using the video loss value, wherein the target network comprises the deformable network.

5. The method according to claim 4, wherein the target network further comprises a three-dimensional Gaussian radiance field, wherein the three-dimensional Gaussian radiance field is used to determine the three-dimensional scene model corresponding to the multi-view images.

6. The method according to claim 2, wherein inputting a target moment into an initial deformable network, to obtain an offset corresponding to the target moment comprises:
combining a temporal feature and a spatial feature of the target moment, to obtain combined feature information; and
inputting the combined feature information into the initial deformable network, to obtain the offset corresponding to the target moment,
wherein the temporal feature of the target moment is determined based on the target moment, and the spatial feature is determined based on a point cloud position of the three-dimensional scene, and the camera pose information corresponding to the multi-view video.

7. The method according to claim 6, wherein the deformable network comprises a multilayer perceptron.

8. The method according to claim 6, wherein the combined feature information comprises a pairwise combination of the temporal feature and spatial features in three dimensions.

9. The method according to claim 1, wherein generating a three-dimensional scene model corresponding to the multi-view images comprises:
obtaining camera pose information corresponding to each of the multi-view images;
performing depth estimation on the multi-view images, to determine sparse point clouds corresponding to the multi-view images; and
generating the three-dimensional scene model corresponding to the multi-view images based on the multi-view images, the camera pose information corresponding to each multi-view image, and the sparse point clouds.

10. The method according to claim 9, wherein the three-dimensional scene model comprises a three-dimensional Gaussian radiance field.

11. The method according to claim 10, wherein the method further comprises:
projecting, for each of a plurality of views, the three-dimensional Gaussian radiance field from the view, comparing a projected image in the view with a multi-view image corresponding to the view, to obtain an image loss value, and optimizing a parameter of the three-dimensional Gaussian radiance field using the image loss value.

12. An electronic device, comprising:
one or more processors; and
a storage apparatus having one or more programs stored thereon, wherein
the one or more programs, when executed by the one or more processors, cause the one or more processors to:
obtain a multi-view video, wherein the multi-view video comprises multi-view images, which include a video frame at an initial moment in the multi-view video;
generate a three-dimensional scene model corresponding to the multi-view images;
determine a deformable network corresponding to the multi-view video based on the three-dimensional scene model, the multi-view video, and camera pose information corresponding to the multi-view video; and
determine a four-dimensional scene model corresponding to the multi-view video based on the three-dimensional scene model and the deformable network.

13. A non-transitory computer-readable medium having a computer program stored thereon, wherein the computer program, when executed by a processor, causes the processor to:
obtain a multi-view video, wherein the multi-view video comprises multi-view images, which include a video frame at an initial moment in the multi-view video;
generate a three-dimensional scene model corresponding to the multi-view images;
determine a deformable network corresponding to the multi-view video based on the three-dimensional scene model, the multi-view video, and camera pose information corresponding to the multi-view video; and
determine a four-dimensional scene model corresponding to the multi-view video based on the three-dimensional scene model and the deformable network.

14. The non-transitory computer-readable medium according to claim 13, wherein the computer program for determining a deformable network corresponding to the multi-view video based on the three-dimensional scene model, the multi-view video, and camera pose information corresponding to the multi-view video further causes the processor to:
input a target moment into an initial deformable network, to obtain an offset corresponding to the target moment;
obtain a three-dimensional scene model at the target moment based on the offset corresponding to the target moment, and the three-dimensional scene model; and
project, for each of a plurality of views, the three-dimensional scene model at the target moment from the view, compare a projected image in the view with a multi-view image corresponding to the view at the target moment, to obtain an image loss value, and optimize the initial deformable network using the image loss value, to obtain the deformable network corresponding to the multi-view video.

15. The non-transitory computer-readable medium according to claim 13, wherein the computer program further causes the processor to:
determine a specified moment and a specified view; and
output scene information corresponding to the specified moment and the specified view.

16. The non-transitory computer-readable medium according to claim 13, wherein the computer program further causes the processor to:
project, for each of a plurality of views, the four-dimensional scene model from the view, compare a projected video in the view with a multi-view video corresponding to the view, to obtain a video loss value, and optimize a network parameter of a target network using the video loss value, wherein the target network comprises the deformable network.

17. The non-transitory computer-readable medium according to claim 16, wherein the target network further comprises a three-dimensional Gaussian radiance field, wherein the three-dimensional Gaussian radiance field is used to determine the three-dimensional scene model corresponding to the multi-view images.

18. The non-transitory computer-readable medium according to claim 14, wherein the computer program for inputting a target moment into an initial deformable network, to obtain an offset corresponding to the target moment further causes the processor to:
combine a temporal feature and a spatial feature of the target moment, to obtain combined feature information; and
input the combined feature information into the initial deformable network, to obtain the offset corresponding to the target moment,
wherein the temporal feature of the target moment is determined based on the target moment, and the spatial feature is determined based on a point cloud position of the three-dimensional scene, and the camera pose information corresponding to the multi-view video.

19. The non-transitory computer-readable medium according to claim 18, wherein the deformable network comprises a multilayer perceptron.

20. The non-transitory computer-readable medium according to claim 18, wherein the combined feature information comprises a pairwise combination of the temporal feature and spatial features in three dimensions.
